(19) United States
(12) Patent Application Publication
(10) Pub. No.: US 2009/0102213 A1
(43) Pub. Date: Apr. 23, 2009

(54) Lifting apparatus

(75) Inventor: Alexander F. Ritchie, Buckle (GB)

Correspondence Address: EDWARDS ANGELL PALMER & DODGE LLP, P.O. BOX 55874, BOSTON, MA, 02205, US

(73) Assignee: Envireneer Marine Cranes Limited, Edinburgh (GB)

(21) Appl. No.: 11/629,032

(22) PCT Filed: Jun. 9, 2005
(86) PCT No.: PCT/GB05/02275

§ 371 Date: Dec. 10, 2008

(30) Foreign Application Priority Data
Jun. 9, 2004 (GB) 0412821.1

(51) Int. Cl. B66C 1/12

(52) U.S. Cl. 294/74

(57) ABSTRACT

The invention relates to a lifting apparatus and in particular to lifting apparatus suitable for lifting casing and pipes for the offshore oil and gas industries. A lifting apparatus (10) is disclosed which comprises a pair of lifting members (13) and an actuator (16). In use, the weight of the actuator imparts a lateral force to the lifting members thereby increasing a lateral separation between distal ends of the lifting members, to move the apparatus from a storage position to an operating position, for lifting a length of casing (30). The lifting members may be rigid or may include a sling (12) and a rigid sling guide (14).

The present invention relates to lifting apparatus and in particular to lifting apparatus suitable for lifting casing and pipes for the offshore oil and gas industries.

In the construction of well bores, well heads, and other installations for the energy or subsea industries, use of components with considerable bulk or mass is common. Specialised lifting equipment is therefore required for loading and unloading the components from and to installation sites, or moving the components around a site after delivery.

In particular, use of large diameter tubular, casing sections and bundles of smaller diameter pipes is prevalent. These tubulars may have diameters of around 40 inches (1 m) and may be 30 to 40 ft (9 to 12 m) or more in length, with the smaller diameter pipes bundled together for lifting purposes. The tubulars will typically be stored lying lengthways in an allocated area. The tubulars, with circular cross-section, have a tendency to roll, and due to their considerable mass will have high momentum. This gives the tubulars the potential to cause damage to surrounding equipment and to endanger the safety of personnel. It is therefore necessary to take extreme care when handling such tubular or casing sections.

In conventional systems, slings are provided around the tubular, which are used to support the load for lifting and manipulation by a crane. In order to provide adequate control over the movement of the tubular and to meet specific safety regulations, the slings will be located towards the middle of the tubular section by up to one quarter distance of the length of the tubular section. Typically, this requires personnel to walk into a “danger region” at either side of the tubular. As soon as an individual moves to the side of a tubular, he is in line with potential movement of the tubular, should the tubular begin to roll. The individual is therefore exposed to an unacceptable degree of danger.

It would therefore be desirable to provide lifting apparatus that mitigated the safety risk to personnel.

A solution to the above-described problem has been suggested which involves the use of a spreader unit supported by a crane. The spreader unit is elongated in one dimension, which is orientated parallel to the tubular lengths, and includes a pair of hydraulically actuated legs designed to increase the elongate length of the spreader units to a length approaching that of the tubular section to be lifted. Slings used to lift the tubular are extended over the length of the spreader unit such that the grabs can be attached close to the ends of the tubular section.

This prior art unit mitigates risk to personnel to an extent. However, the spreader unit is bulky and massive, and therefore is limited in its application to offshore environments. Furthermore, the prior art unit operates by means of a hydraulic system requiring specific actuation. The hydraulic system in itself increases complexity and is expensive to manufacture.

It would therefore be desirable to have lifting apparatus that improved upon the prior art.

It is one aim of the invention to provide lifting apparatus that mitigates risk to personnel.

It is another aim of the invention to provide lifting apparatus with relatively low bulk and mass when compared with available systems.

It is another aim of the invention to provide lifting apparatus that may automatically spread lifting members, without need for a hydraulic actuator or a separately powered actuator.

Other aims and objects of the invention will become apparent from reading the following description.

According to a first aspect of the present invention, there is provided lifting apparatus comprising a pair of lifting members and an actuator, wherein in use, the weight of the actuator imparts a lateral force to the lifting members, thereby increasing a lateral separation between distal ends of the lifting members.

The apparatus may be moveable between a first, storage position and a second, operating position in which distal ends of the lifting members are separated, and the weight of the actuator may facilitate movement of the apparatus from the first, storage position to the second, operating position.

According to a second aspect of the invention, there is provided lifting apparatus having an actuator and a pair of lifting members, wherein the apparatus is moveable between a first, storage position and a second, operating position in which distal ends of the lifting members are separated, and wherein the weight of the actuator facilitates a movement of the apparatus from the first, storage position to the second, operating position.

The invention therefore provides lifting apparatus where the self-weight of the actuator may be employed for increasing the lateral separation between the distal ends of the lifting members, in preparation for lifting a load such as a bundle of tubulars. This avoids a requirement to provide a complex and expensive actuating system such as a hydraulic system.

Preferably, the lifting members each comprise a lifting sling and a sling guide for the lifting sling. The apparatus may therefore comprise a pair of lifting slings and a pair of sling guides for the lifting slings. In use, the weight of the actuator may impart a lateral force to the sling guides, thereby increasing a lateral separation between distal ends of the lifting slings. In a similar fashion, where the apparatus is moveable between a first, storage position and a second, operating position, distal ends of the lifting slings may be separated on movement of the apparatus to the second position. The lifting members, may alternatively be one-piece or unitary members, may be substantially rigid and may be rods, poles, tubes or the like.

The weight of the actuator may effect movement of the apparatus from the first position to the second position. Thus the weight of the actuator may cause movement of the apparatus from the first position to the second position. Alternatively, the actuator may be adapted to move the apparatus to the second position following application of an initial external force. For example, an external force may be applied to initially move the apparatus from the first position a small part of the way towards the second position. Following such initial movement, the actuator may take over and may continue movement of the apparatus to the second position, effected by the weight of the actuator. The external force may be applied manually, for example, by an operator exerting a force on one or both of the lifting members. Indeed, the apparatus may be designed such that it is only necessary to exert a force on one of the lifting members in order to commence movement of the apparatus.

Preferably, the sling guides are substantially rigid.

The sling guides may be tubular members, each comprising a bore through which a lifting sling extends. The slings may be moveable relative to the sling guides.

Preferably, the apparatus comprises a master link assembly for coupling the apparatus to a lifting equipment such as a crane, and an actuator retainer, wherein the actuator retainer is suspended from the master link assembly. More preferably, the actuator comprises a block slidably mounted on the actuator retainer. In the context of this description, the term block should not be interpreted as being limited to any particular shape. More preferably, the block comprises a through-bore into which a rod of the actuator retainer is received. Optionally, the rod and through-bore are arranged to prevent relative rotation between the actuator and actuator retainer. The actuator retainer may comprise a base plate or base pin for defining a lower position of the block. Preferably, a damper is disposed between the weight and the base plate or base pin.

Preferably, each lifting member and in particular each sling guide is coupled to the actuator by a link arm. More preferably, each link arm is pivotally connected to the actuator and to its lifting member/sling guide. The link arms may be arranged to initially restrain the actuator against movement to impart the lateral force on the lifting members, and may therefore be adapted to initially restrain the apparatus in the first, storage position. To achieve this, the link arms may be initially arranged in a position where the arms are substantially parallel to the lifting members. In this fashion, all of the force initially exerted on the lifting members by the actuator may be directed along the length of the lifting members (and typically initially vertically), preventing the actuator from imparting lateral forces on the lifting members.

Preferably, the actuator is provided with a locking member, which may be in the form of a support sling, for holding or suspending the apparatus in a storage position. The locking member may be coupled to the actuator, for restraining the actuator against movement to impart lateral forces to the lifting members. Alternatively, where the lifting members are coupled to the actuator by link arms, the link arms may be adapted to restrain the apparatus in the storage position. The support sling may therefore serve for preventing accidental actuation of the apparatus. In a further alternative, the apparatus may include a locking member adapted to be coupled between the lifting members, for restraining the lifting members against movement and thus restricting lateral separation of the distal ends thereof. The locking member may be a bar, rod, chain, strap or the like, or the lifting members may carry hooks for lifting a load, which may be coupled together to hold the apparatus in the storage position.

Preferably, the lifting slings are suspended from the master link assembly.

Preferably, in the second operating position, the weight of the actuator is supported by the base plate or base pin of the actuator retainer.

Preferably, in the second operating position, the weight of the block imparts a lateral force to the sling guides via the link arms.

The apparatus may also comprise a support device for the lifting members, which may enable the lifting members to support a load exerted on the members by the actuator. In particular, the support device may enable the lifting members to support a vertical load or a vertical component of a load exerted thereon by the actuator. The support device may comprise a support coupled at one end to one lifting member, at an opposite end to the other lifting member and at a point along the length of the support between said ends to a fixed location. The support may be coupled at a midpoint to the fixed location. The fixed location may be provided on or may be defined by the actuator retainer, and may be fixed in that the lifting members and/or the actuator may be moveable relative to the fixed location. In an alternative, the support device may comprise at least two supports, one associated with each lifting member and extending between the lifting member and the fixed location. The support device may be required where the lifting members comprise a sling and a sling guide, and the support(s) may be coupled to the sling guide(s). The support(s) may be flexible and may be a sling, or where two supports are provided, the supports may be substantially rigid, such as rods or tubes.

According to a third aspect of the invention, there is provided lifting apparatus comprising a pair of lifting slings, an actuator and a pair of sling guides for the lifting slings, wherein in use, the weight of the actuator imparts a lateral force to the sling guides, thereby increasing a lateral separation between distal ends of the lifting slings.

According to a fourth aspect of the invention, there is provided lifting apparatus having an actuator, a pair of lifting slings, and a pair of sling guides for the lifting slings, wherein the apparatus is movable between a first storage position and a second operating position in which distal ends of the lifting slings are separated, and wherein the weight of the actuator effects a movement of the apparatus from the first storage position to the second operating position.

According to a fifth aspect of the invention, there is provided a method of lifting an article, the method using the apparatus according to any one of the first, second, third or fourth aspect of the invention.

There will now be described, by way of example only, an embodiment of the invention with reference to the following drawings, of which:

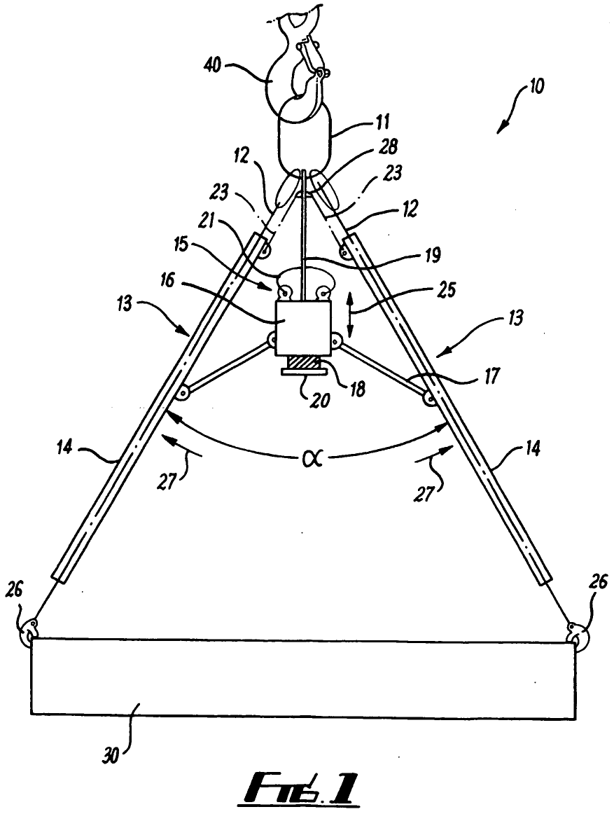

FIG. 1 is a side view of a lifting apparatus in accordance with an embodiment of the invention;

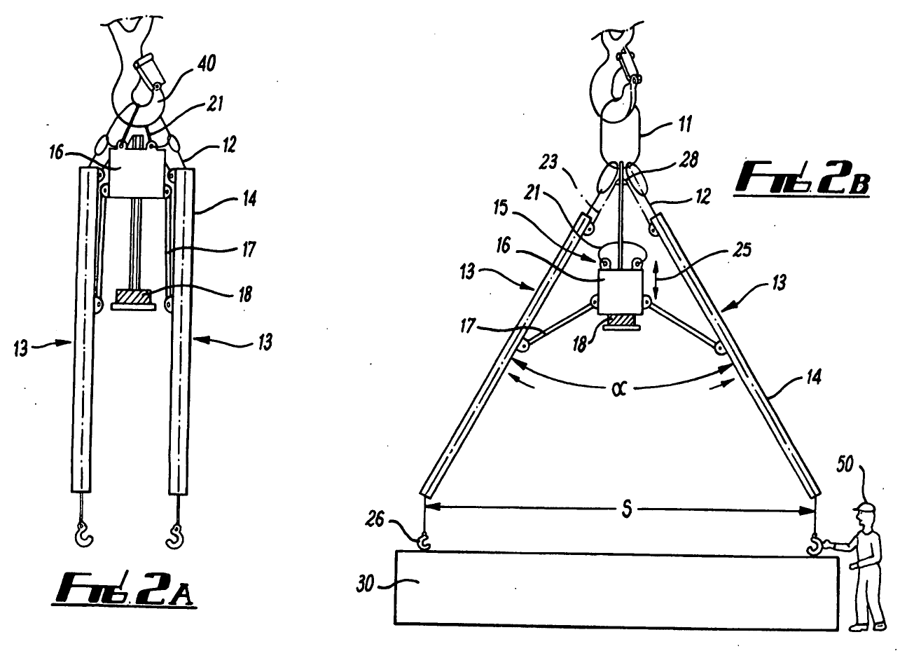

FIG. 2A is a side view of the lifting apparatus of FIG. 1 in a storage position;

FIG. 2B is a side view of the lifting apparatus of FIG. 1 before a load is attached.

Referring to the Figures, there is shown apparatus in accordance with an embodiment of the invention, generally depicted at 10. The apparatus comprises a pair of lifting members 13 each comprising a lifting sling 12 and a sling guide 14, and an actuator assembly 15. The apparatus therefore comprises a pair of lifting slings 12 and a pair of sling guides 14. The apparatus 10 also comprises a master link assembly 11 for coupling the apparatus to a crane 40. The lifting slings are any suitable grade cable, and have at their distal ends pipe-lifting hooks 26. These pipe lifting hooks 26 function to engage with the casing 30 to be lifted. When the apparatus is employed for lifting pipe bundles, hooks will typically function to engage with separate lifting slings located around the pipe bundle.

The sling guides 14 are tubular members, having a bore through which the lifting slings 12 pass. The sling covers are rigid, or substantially rigid, in order to provide structural support to the apparatus. The sling guides 14 must have sufficient rigidity to remain straight enough to maintain the lateral separation between distal ends of the lifting slings 12 during an attachment procedure. The sling covers 14 are for example tubular steel members.

The actuator assembly 15 comprises a weight 16 mounted on an actuator retainer 19. The actuator retainer 19 is arranged to be supported by the master link assembly 11. The weight 16 is slideably mounted on the actuator retainer 19 allowing relative movement between the actuator retainer and the weight in the direction shown by arrow 25. The actuator retainer 19 has a square section steel rod, received in a square bore in the weight 16. The rod and the bore fit together such that relative rotational movement between the actuator retainer 19 and the weight 16 is prevented. It will be appreciated that alternative cross-sectional shapes of actuator retainer and bore will be suitable.

The actuator retainer comprises a base plate 20, for limiting the extent of travel of the weight 16. Between the weight 16 and the base plate, a rubber damper 18 is located. This rubber damper functions to partially absorb the impact between the weight 16 and the base plate 20 during use. In addition, the position of the damper and/or base plate is adjustable to allow the fine tuning of the extent of travel of the weight on the actuator retainer. This allows tuning of the angle a between the sling guides 14.

In alternative embodiments of the invention, the base plate 20 and/or the rubber damper 18 may be replaced by a base pin or coil spring respectively, to perform the same functions.

In order to retain the proximal ends of the sling guides on the apparatus, a support device in the form of a secondary sling 23 is provided. The secondary sling 23 is attached at each of its ends to a proximal end of the apparatus, and is secured to the actuator retainer 19. As the sling guides 14 are freely mounted on the slings 12, the secondary sling 23 supports the sling guides 14, enabling the sling guides 14 to support axially directed loads exerted on the guides 14 by the actuator 16. It will be understood that where the lifting members 13 are alternatively provided as substantially rigid rods or tubes, the secondary sling 23 may not be required. This is because such rigid lifting members would be capable of supporting axially directed loads exerted thereon by the actuator 19.

The secondary sling 23 is secured at one end to one of the sling guides 14, at a midpoint to the actuator retainer 19 by a clamp 28, and at an opposite end to the other sling guide 14. The sling 23 is thus securely clamped to the actuator retainer, such that the lengths of the sections of the sling 23 extending between the clamp 28 and each sling guide 14 are the same. This ensures correct operation of the apparatus 10, as any variation in the lengths of the sections of the sling 23 could result in all of the actuator 16 loading being transmitted only to one of the sling guides 14, therefore the apparatus may not open correctly.

An upper portion of the weight 16 has mounted thereto a support or storage sling 21. This storage sling allows lifting of the apparatus by a force supporting the actuator assembly, rather than lifting by using the lifting slings 12, as will be described in more detail below.

Mounted to the weight 16 is a pair of link arms 17. The link arms 17 are mounted on diametrically opposed sides of the weight 16 and are pivotally connected to the weight by means of pin mounting arrangements at the first (upper) ends of the link arms. At the second (lower) ends of the link arms 17, similar pin mounting arrangements are provided to pivotally mount the link arms to the sling guides 14.

FIG. 2A shows the lifting apparatus in a storage state. The apparatus is suspended by the storage sling 21, which is attached directly to the weight 16 which slides upwardly relative to the actuator retainer 19. The lifted position of the weight 16 induces the linking arms and sling covers to a retracted position, with the sling covers hanging substantially vertically. This storage position reduces the lateral extension of the apparatus and allows it to be conveniently stowed, for example by hanging the apparatus on a suitable structure by the storage sling 21. If necessary, the sling covers and other parts of the apparatus can be securely tied to avoid free movement.

FIG. 2B shows the lifting apparatus 10 suspended by the master link 11 prior to attachment to a tubular section 30. In contrast to the position shown in FIG. 2A, the storage sling 21 has been released, allowing the weight to slide down the actuator retainer 19 until it abuts the damper 18. The gravitational force which induces downward movement of the weight imparts an outward force onto the sling covers 14 by virtue of the pivotally mounted link arms 17. The weight 16 must be of sufficient mass to provide a force that overcomes the inward moment caused by the weight of the sling guides 14, link arms 17, lifting slings 12 and hooks 26.

The sling guides extend to a maximum angle a determined by the geometry of the link arms and the distance between the upper suspended part of the actuator retainer and the damper. The distal ends of the sling guides 14 cause the ends of the lifting sling 12 to be separated laterally by a separation distance S. In this example, the separation distance approaches the length of the casing section 30. The operating personnel attach the hooks 26 to the lifting slings of the pipe bundle or rim of the casing section.

In use of the apparatus 10, the storage sling 21 either acts as a primary support, to retain the apparatus 10 in the storage state, or serves to prevent accidental actuation of the device. In particular, in the illustrated embodiment, the link arms 17 are disposed at a small angle relative to the sling guides 14, when in the storage position of FIG. 2A. In this fashion, when the storage sling 21 is released from the crane 40, the actuator 16 exerts a force on the sling guides 14 which has a primary component directed along a length of the sling guides 14, and thus has a mainly vertical component.

As the link arms 17 are at a slight angle relative to the sling guides 14, the force transmitted to the sling guides 14 also has a small lateral or horizontal component. This is sufficient to cause the sling guides 14 to commence movement and thus separation of the guides. Accordingly, under these circumstances, the storage sling 21 acts to prevent the apparatus 10 from moving to the deployed position of FIG. 2B.

In a variation, the apparatus 10 is configured so that the link arms 17 are parallel to the sling guides 14 when in the storage position of the apparatus 10 shown in FIG. 2A. The force exerted on the sling guides 14 by the actuator 16 then has no lateral or horizontal component. Accordingly, the entire force transmitted to the sling guides 14 is directed along a length of the guides 14 and thus substantially vertically. This force is carried by the master link 11 through the secondary sling 23. Under these circumstances, the link arms 17 brace and retain the apparatus 10 in the storage position, and the storage sling 21 is not required, save as a backup, to prevent accidental actuation of the apparatus 10 and/or for storage purposes.

When it is desired to move the apparatus 10 to the position of FIG. 2B, a relatively small lateral force is exerted on one (or both) of the sling guides 14, for example, by an operator. This causes the link arms 17 to move to a position where they are at an angle (non-parallel) relative to the sling guides 14. The actuator 16 then exerts forces on the sling guides 14 with progressively increasing horizontal components, to carry the apparatus 10 to the FIG. 2B position.

Once in the operating position, the link arms 17 brace the sling guides 14, and the apparatus 10 is returned to the storage position either by lifting the storage sling 21, or by carrying the two sling guides 14 back towards the vertical storage position. It will be understood that the bracing force exerted on the sling guides 14 by the link arms 17 prevents accidental closure by movement of one of the sling guides 14.

In the embodiment described, the apparatus is configured such that the lifting force required to lift a particular length of tubular is transferred solely through the lifting slings and master link assembly, without imparting a downward or inward force on the distal ends of the sling guides 14. This means that the weight 16 need only be sufficient to act against the inward and downward force due to the weight of the apparatus itself.

This configuration can be adjusted by altering the position of the damper 18 and base plate 20.

If, however, the hooks were used to lift a short length of pipe or casing, an addition force due to the weight of the load would act on the distal ends of the sling guides and tend to close them. In this situation, the weight 16 could be selected to be sufficiently large to overcome the component of the load acting to close the sling guides.

The present invention provides an automatic spreading device for a pair of lifting slings. This allows convenient attachment of lifting hooks located at the end of the slings to the tubular section or sections. Significantly, the apparatus reduces the requirement for personnel to stand in a danger area at the side of a tubular. In many implementations, it is envisaged that personnel will be able to reach the distal ends of the lifting slings from an end position of the tubular, as indicated by the location of the operator 50 shown in FIG. 2B.

It would be appreciated by one skilled in the art that various modifications may be made to the described example within the scope of the invention herein intended. For example, the selection of steel tubulars for the sling guides 14 (or sling covers), could be replaced by the use of alternative sling guides. Alternative embodiments of the invention could comprise three or more lifting members/slings and sling guides.

The apparatus is also suitable for lifting equipment and components other than tubular.

The lifting members, may be one-piece or unitary members, may be substantially rigid and may be rods, poles, tubes or the like.

The apparatus may include a locking member adapted to be coupled between the lifting members, for restraining the lifting members against movement and thus restricting lateral separation of the distal ends thereof. The locking member may be a bar, rod, chain, strap or the like, or the lifting members may carry hooks for lifting a load, which may be coupled together to hold the apparatus in the storage position.

The support device of the apparatus may comprise at least two supports, one associated with each lifting member and extending between the lifting member and the fixed location. The supports may be substantially rigid, such as rods or tubes.

1-42. (canceled)

43. A lifting apparatus comprising:
a pair of lifting members; and
an actuator, wherein in use, the weight of the actuator imparts a lateral force to the lifting members, thereby increasing a lateral separation between distal ends of the lifting members, wherein the lifting members each comprise a lifting sling and a substantially rigid sling guide for the lifting sling, and the slings are movable relative to the sling guide.

44. A lifting apparatus as claimed in claim 43, wherein the sling guides are tubular members, each comprising a bore through which a lifting sling extends.

45. A lifting apparatus as claimed in claim 43, wherein the apparatus is moveable between a first, storage position and a second, operating position in which distal ends of the lifting members are separated.

46. A lifting apparatus as claimed in claim 45, wherein the actuator is adapted to move the apparatus to the second position following application of an external force to move the apparatus from the first position part of the way towards the second position, whereupon the actuator takes over and continues movement of the apparatus to the second position, effected by the weight of the actuator.

47. A lifting apparatus as claimed in claim 43, wherein in use, the weight of the actuator imparts a lateral force to the sling guides, thereby increasing a lateral separation between distal ends of the lifting slings.

48. A lifting apparatus as claimed in claim 43, comprising a support device for the lifting members, which enables the lifting members to support a load exerted on the members by the actuator.

49. A lifting apparatus as claimed in claim 48, wherein the support device comprises a support coupled at one end to one sling guide, at an opposite end to the other sling guide and at a point along the length of the support between said ends to a fixed location.

50. A lifting apparatus as claimed in claim 48, wherein the support device comprises at least two supports, one associated with each sling guide and extending between the sling guide and the fixed location.

51. A lifting apparatus as claimed in claim 43, wherein the apparatus comprises a master link assembly for coupling the apparatus to lifting equipment, and an actuator retainer, wherein the actuator retainer is suspended from the master link assembly.

52. A lifting apparatus as claimed in claim 51, wherein the apparatus is moveable between a first, storage position and a second, operating position in which distal ends of the lifting members are separated, and wherein in the second operating position, the weight of the actuator is supported by the base plate of the actuator retainer.

53. A lifting apparatus as claimed in claim 51, wherein the apparatus is moveable between a first, storage position and a second, operating position in which distal ends of the lifting members are separated, and wherein in the second operating position, the weight of the block imparts a lateral force to the sling guides via link arms.

54. A lifting apparatus as claimed in claim 51, wherein the actuator comprises a block slidably mounted on the actuator retainer and a base plate for defining a lower position of the block.

55. A lifting apparatus as claimed in claim 43, wherein each lifting member is coupled to the actuator by a link arm, wherein each link arm is pivotally connected to the actuator and to its lifting member.

56. A lifting apparatus as claimed in claim 55, wherein the link arms are adapted to initially restrain the apparatus in a first, storage position.

57. A lifting apparatus as claimed in claim 55, wherein the link arms are initially arranged in a position where the arms are substantially parallel to the lifting members.

58. A lifting apparatus as claimed in claim 43, wherein the actuator is provided with locking member for holding the apparatus in a storage position.

59. A lifting apparatus as claimed in claim 58, wherein the locking member is a support sling coupled to the actuator, for restraining the actuator against movement to impart lateral forces to the lifting members.

60. A lifting apparatus as claimed in claim 58, wherein the apparatus comprises a locking member adapted to be coupled between the lifting members, for restraining the lifting members against movement and thus restricting lateral separation of the distal ends thereof.

61. A lifting apparatus as claimed in claim 43, wherein the apparatus comprises a master link assembly for coupling the apparatus to lifting equipment, and an actuator retainer, wherein the actuator retainer is suspended from the master link assembly; and wherein the lifting slings are suspended from the master link assembly.

62. A method of lifting an article, the method using the apparatus according to claim 43.
